(19) United States
(12) Patent Application Publication
(10) Pub. No.: US 2003/0023426 A1
(43) Pub. Date: Jan. 30, 2003

(54) Japanese language entry mechanism for small keypads

(75) Inventors: Samuel Yin Lun Pun, Calgary (CA); Kevin Qingyuan Zeng, Calgary (CA); Wallace Ritchie, Daytona Beach, FL (US); Vladimir Orel, Ewing, NJ (US); Peter Hubert Ackermans, Calgary (CA); Changshi Xu, Calgary (CA); Vanessa Sherr, Calgary (CA); Robert B. O'Dell, Oakland, CA (US); Antoine Blondeau, San Jose, CA (US)

Correspondence Address: James D. Ivey, Law Offices of James D. Ivey, 3025 Totterdell Street, Oakland, CA, 94611-1742, US

(73) Assignee: Zi Technology Corporation Ltd.

(21) Appl. No.: 09/888,222

(22) Filed: Jun. 22, 2001

(51) Int. Cl. G06F 17/27

(52) U.S. Cl. 704/9

(57) ABSTRACT

Japanese kanji-kana words intended to be entered by a user are predicted from relative few key presses, each single key press indicating a group kana syllables of the fifty sounds table. Text input logic collects all known words which include any syllables of the groups specified in the order specified and sorts the words by relative frequency to predict which word the user is intending to enter. All known words which match the same consonant pattern are collected and those most frequently used are presented at the top of the list from which the user can select the intended word. Predicted word selections are presented to the user in kanji-kana form such that kana-kanji conversion is unnecessary.

### FIELD OF THE INVENTION

This invention relates to the field of text entry in electronic devices, and more specifically to the entry of Japanese characters into an electronic device.

### BACKGROUND OF THE INVENTION

Japanese is written with the use of four sets of symbols: their own set of Chinese characters (“kanji”); two phonetic syllabaries, hiragana and katakana, which are referred to collectively as “kana”; and Western alphabet (“romaji”). Romaji appears only rarely, usually only in reference to Western company names or acronyms. While it is possible to write Japanese using just kana, such is not the accepted practice. Instead, noun, verb base, and adjective base are typically written in kanji while sentence interjectives, pre-nouns, relationals, adverbs, copula, and sentence particles are typically written in kana. Of the kana, hiragana is the most commonly used—typically to add inflections to the characters and is used instead of kanji for some Japanese words. Katakana is used primarily for words of foreign—usually Western—origin, and represents only about 5% of the language symbols seen on a typical newspaper page. Many kana combinations have an equivalent representation in kanji.

The kana structure of the Japanese language is predicated entirely upon sound and variations of sound. The hiragana characters comprise the round form, and the katakana comprise the square form. The sounds are essentially the same but the use of either kana implies either Japanese or foreign cultural bias. Foreign words are written in the square (harsh and angular) form to enable easy distinction. Each character set contains 46 base characters that may be used in combination and in conjunction with special variants which change or modify sound values. These variants are the diacritical marks and the small forms. The diacritical marks are used to indicate that a kana's consonant sound should be altered when pronouncing one of the syllables in a particular word. The small form of kana indicate the sound of the preceding kana should be contracted and run together with the sound of one of the three small-size kana (ya, yu, and yo).

Including each of the sounds of kana in a keyboard would require a keyboard having at least 50 different character keys. In devices, particularly small devices such as telephones, personal digital assistants (PDAs), and laptop computers, this is impractical. Existing systems utilize keyboards specifically designed for Japanese text input using the 46 sounds of the base characters of kana which form the “fifty sounds table.” Such conventional systems require separate keys for each of the sounds. In addition, some currently available systems utilize an English keyboard to phonetically input the sounds of the 46 sounds using the English alphabet (essentially typing Japanese using romaji) and convert the romaji text into either kana or kana-kanji. This system may be difficult for Japanese users who are unfamiliar with the English alphabet since romaji is so infrequently used in Japan. It is therefore desirable to provide a system for Japanese text input that utilizes relatively Few entry keys and may be easily used by operators who may not be familiar with the English alphabet.

### SUMMARY OF THE INVENTION

In accordance with the present invention, words intended to be entered by a user are predicted from relative few key presses, each single key press indicating a group syllables. The syllables of the fifty sounds table are organized into rows corresponding to consonants and columns corresponding to vowels. One row of syllables corresponds to vowel sounds without any consonant; this group is therefore considered associated with a null consonant herein. Fluent speakers of the Japanese language are very familiar with the organization of the fifty sounds table. Accordingly, association of each consonant group (including the null consonant group) of syllables with an individual key of a small keypad is a convenient organization of syllables for a fluent speaker of the Japanese language. In addition, since there are ten (10) groups of syllables, the mapping of syllable groups to keys of a numeric keypad is particularly convenient.

The pressing of a key therefore identifies a group of syllables and not the individual syllable within the group. Text input logic collects all known words which include any syllables of the groups specified in the order specified and sorts the words by relative frequency to predict which word the user is intending to enter. It can be considered that the user is entering the consonant of each syllable of the intended word and, by use of statistical predictive analysis, the most likely words are presented to the user for selection. It is helpful to consider the following example in which the user intended to enter “arigato” or “thank you.” The user simply spells out the consonants of each syllable using a numeric keypad: 1-9-2-4 (null consonant, “r,” “k” which includes the equivalent of the English “g” consonant, and “t”). All known words which match the same consonant pattern are collected and those most frequently used are presented at the top of the list from which the user can select the intended word. Thus, text entry for the Japanese language approaches the impressive ratio of one key press per syllable.

Further in accordance with the present invention, predicted word selections are presented to the user in kanji-kana form. The characters of the fifty sounds table can be used to write any word of the Japanese language. However, such is not typically done. Instead, kanji is used for much of the written language as described above. Accordingly, looking at predicted words in kana only looks awkward to fluent Japanese speakers. To provide a more palatable experience for the user, the predicted words are converted to an appropriate combination of kanji and kana prior to display to the user such that the user can select from a list of words that just simply look right.

Thus, the result is a very powerful and convenient text entry user interface for the Japanese language which works particularly well with rather limited keypads.

### BRIEF DESCRIPTION OF THE DRAWINGS

FIG. 1 is a representation of the fifty sounds table used in accordance with the present invention.

FIG. 2 is a key map which shows mapping of consonant groups of syllables to numeric keys for use in text entry according to the present invention.

FIG. 3 is a block diagram of a device which performs text entry in accordance with the present invention.

FIG. 4 is a logic flow diagram illustrating text entry in accordance with the present invention.

FIGS. 5-16 are diagrammatic views of a display screen collectively showing an interactive text entry session as an illustrative example of the processing of the logic flow diagram of FIG. 4.

FIG. 17 is a block diagram of the predictive database of FIG. 3 in greater detail.

FIG. 18 is a block diagram equally illustrative of the primary and the secondary stem tables of FIG. 17 in greater detail.

FIG. 19 is a block diagram of the ending table of FIG. 17 in greater detail.

FIGS. 20-34 show the same illustrative example as do FIGS. 5-16 but in a preferred embodiment of the present invention.

### DETAILED DESCRIPTION

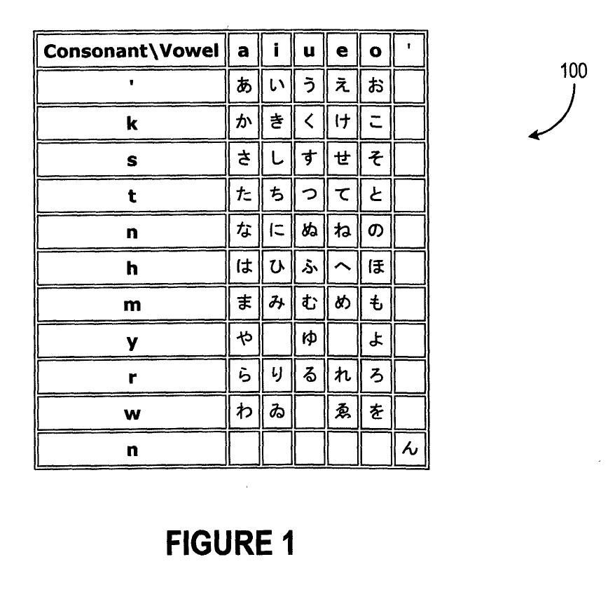

In accordance with the present invention, each key-press of the user identifies a group of characters of the fifty sounds table 100 (FIG. 1) and the particular character of the group is identified according to statistical predictive analysis of the keys pressed by the user. In addition, after each key press, kana-kanji conversion is used to improve prediction of the text being entered by the user.

To facilitate understanding and appreciation of the present invention by non-Japanese speakers, the fundamentals of the Japanese kana alphabet are briefly described. Fifty sounds table 100 illustrates the elemental syllables of Japanese as hiragana. Katakana has an equivalent fifty sounds table which is well-known and is not shown. Fifty sounds table 100 is as fundamental to the Japanese written language as the English alphabet is to the written English language. The order and organization shown in FIG. 1 is memorized and well-known by school-age children in Japan.

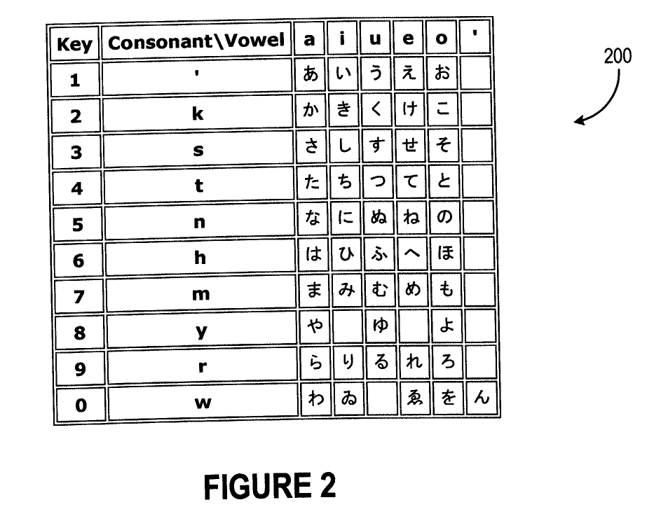

Each row of fifty-sounds table 100 represents a consonant group of syllables. It should be appreciated that the first row of fifty-sounds table 100 represents vowels-only syllables and is therefore herein considered a consonant group in which the subject consonant is a null consonant for ease of explanation and simplicity of description. Each column of fifty-sounds table 100 represents a vowel group of syllables. The last column represents a null vowel and only includes a single consonant-only syllable, namely, “n′.” Fifty-sounds table 100 is reorganized slightly to produce key map 200 (FIG. 2). Key map 200 also groups syllables into consonant groups (represented by individual rows) and vowel groups (represented by individual columns). The syllables of key map 200 are substantially analogous in position and organization to the syllables of fifty-sounds table 100.

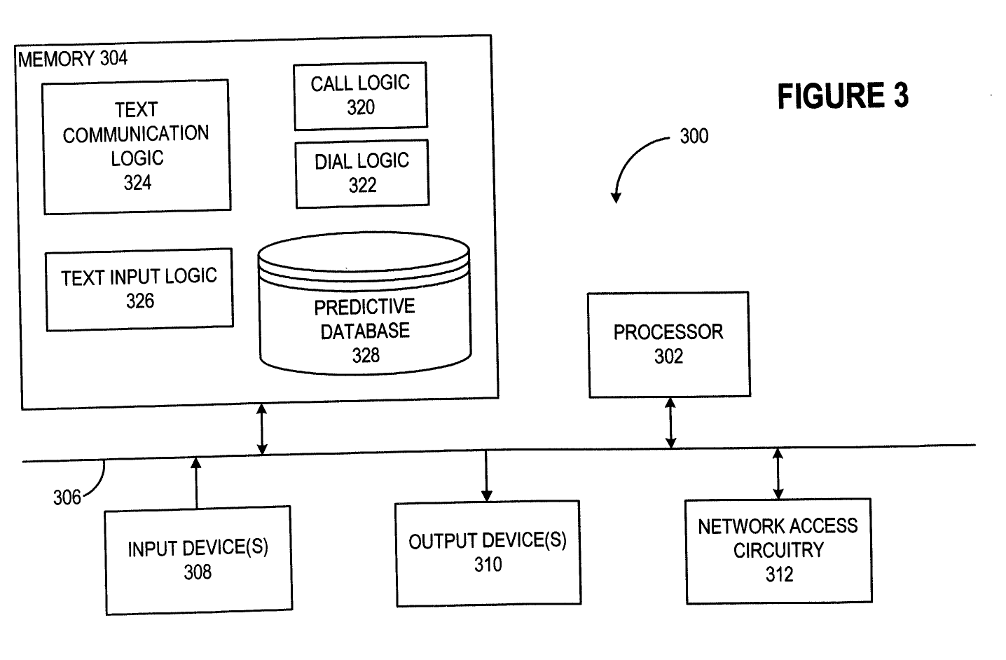

Device 300 is a shown in diagrammatic form in FIG. 3. In this illustrative embodiment, device 300 is a wireless telephone with text messaging capability. Device 300 includes a microprocessor 302 which retrieves data and/or instructions from memory 304 and executes retrieved instructions in a conventional manner.

Microprocessor 302 and memory 304 are connected to one another through an interconnect 306 which is a bus in this illustrative embodiment. Interconnect 306 also connected one or more input devices 308, one or more output devices 310, and network access circuitry 312. Input devices 308 include a typical wireless telephone keypad in this illustrative embodiment and a microphone. Output devices 310 include a liquid crystal display (LCD) in this illustrative embodiment in addition to a speaker for playing audio received by device 300 and a second speaker for playing ring signals. Input devices 308 and output devices 310 can also collectively include a conventional headset jack for supporting voice communication through a convention headset. Network access circuitry 312 includes a transceiver and an antenna for conducting data and/or voice communication through a network.

Call logic 320 is a collection of instructions and data which define the behavior of device 300 in communicating through network access circuitry 312 in a conventional manner. Dial logic 322 is a collection of instructions and data which define the behavior of device 300 in establishing communication through network access circuitry 312 in a conventional manner. Text communication logic 324 is a collection of instructions and data which define the behavior of device 300 in sending and receiving text messages through network access circuitry 312 in a conventional manner.

Text input logic 326 is a collection of instructions and data which define the behavior of device 300 in accepting textual data from a user. Such text entered by the user can be sent to another through text communication logic 324 or can be stored as a name of the owner of device 300 or as a textual name to be associated with a stored telephone number. As described above, text input logic 326 can be used for endless applications other than text messaging between wireless devices. Predictive database 328 stores data which is used to predict text intended by the user according to pressed keys of input devices 308 in a manner described more completely below.

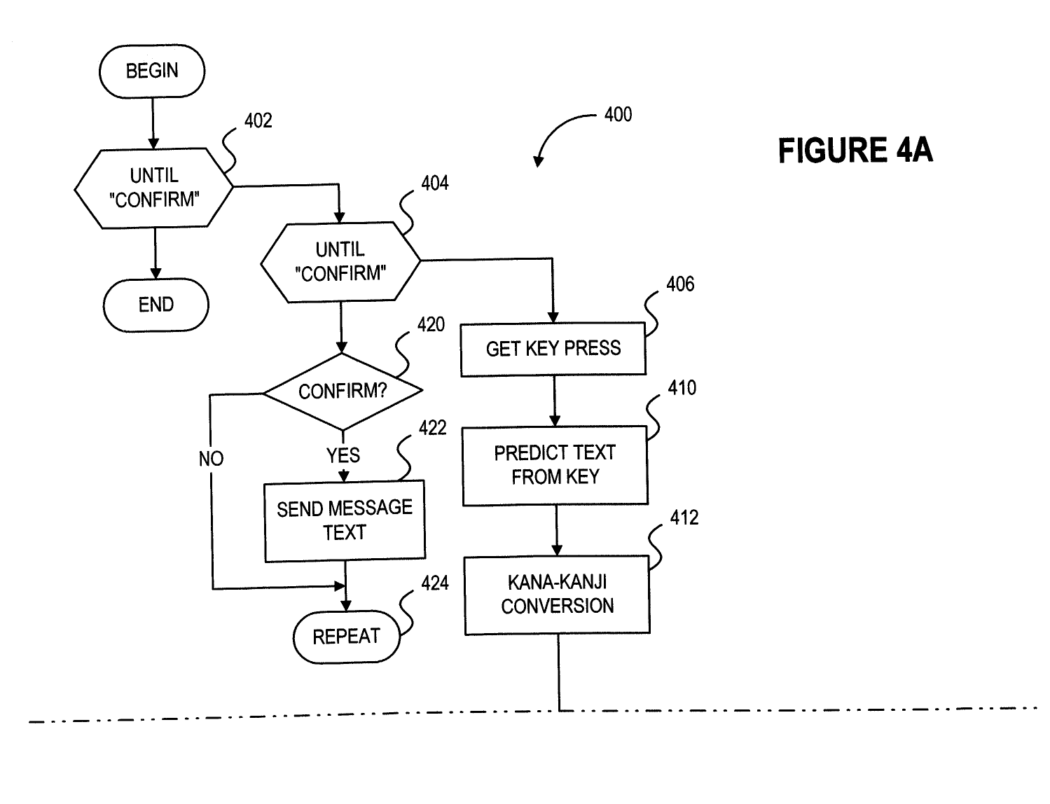

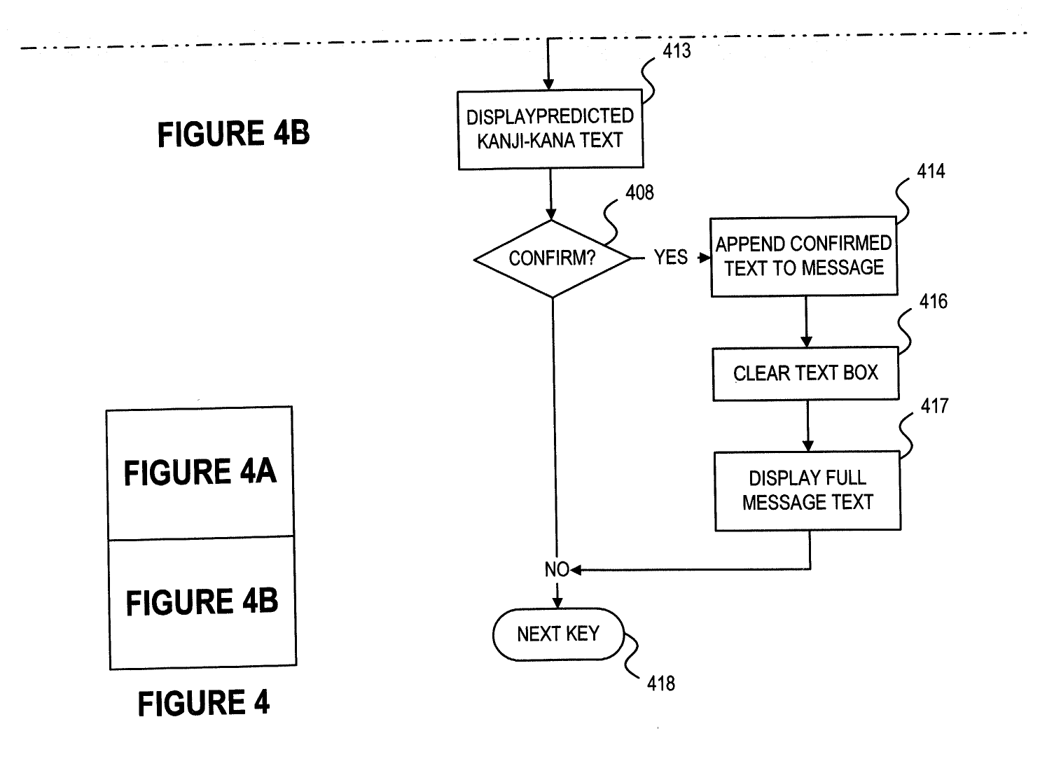

Logic flow diagram 400 (FIG. 4) illustrates the behavior device 300 (FIG. 3) according to text input logic 326 of this illustrative embodiment. Loop step 402 (FIG. 4) and next step 424 define a loop in which words or phrases are entered by the user according to steps 404-422 until the user indicates that the message is complete. For each word or phrase, processing transfers to loop step 404.

Loop step 404 and next step 418 define a loop in which a single word or phrase is entered by the user according to steps 406-417. The remainder of logic flow diagram 400 is described in the context of an illustrative example in which the user wishes to enter the Japanese equivalent of “thank you very much for yesterday.” Prior to considering entry of this sentence in a manner according to the present invention, it is helpful to consider entry of this sentence using currently available “multi-tap” systems.

Multi-tap systems associate multiple characters with a single key and the user presses the key a predetermined number of times to indicate which character is intended. Consider for example key map 200. The “5” key of a wireless telephone is associated with the “n” consonant group. In a multi-tap system, the “5” key is pressed once for “na,” twice for “ne,” thrice for “ni,” four times for “no,” and five times for “nu.” “Thank you very much for yesterday” is “kino ha arigato gozaimasu” in Japanese. To spell this out using key map 200 and multi-tap systems requires the following sequence of key presses: 2-2-<pause>-5-5-5-5-5-<pause>-1-1-1-<pause>-6-<pause>-1-<pause>-9-9--<pause>-2-#-<pause>-4-4-4-4-4-<pause>-1-1-1-<pause>-2-2-2-2-2-#-<pause>-3-#-<pause>-1-1-<pause>-7-<pause>-3-3-<pause>-4-<pause>. In typical multi-tap systems, a pause confirms that a particular key has been pressed an appropriate number of times. In addition, the “#” key indicates that a diacritical is to be added to the syllable.

Thus, 38 key-presses are required to enter the phrase “thank you very much for yesterday.” At this point, the phrase is still in hiragana form. The user presses another key to perform a kana-kanji conversion in which the hiragana is converted to a kanji-kana combined form preferred by Japanese readers in a known and conventional manner. Pressing a 40^{th} key indicates that the message is complete.

In accordance with the present invention, the same phrase is entered and represented in the preferred kanji-kana combined form in only twelve (12) key presses—less than one-third of those required by multi-tap systems.

In step 406 (FIG. 4), text input logic 326 (FIG. 3) retrieves data representing a key of input device 308 pressed by the user. In this illustrative example, the key pressed is the “2” key.

In step 410, text input logic 326 (FIG. 3) predicts the text intended by the user according to keys pressed thus far. Text input logic 326 makes such a prediction from predictive database 328 in a manner described more completely below. The key pressed in this illustrative example is the “2” key which represents the “k” consonant group. In this illustrative example, text input logic 326 predicts that a word starting a sentence and beginning with a “k” syllable is most likely “kurai” which means rank or position.

In step 412 (FIG. 4), text input logic 326 (FIG. 3) performs kana-kanji conversion to produce an appropriate representation of any word or phrase thus far in kanji and/or hiragana.

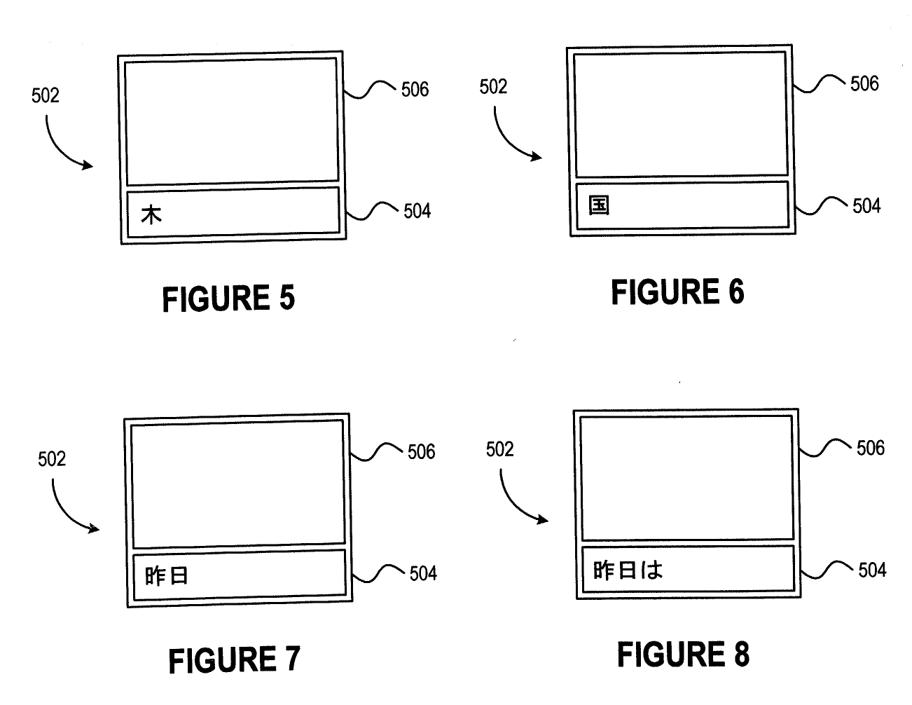

In step 413 (FIG. 4), text input logic 326 (FIG. 3) displays the results of step 412 in an output device 310, typically an LCD screen in this illustrative embodiment. Such a display screen 502 is shown in FIG. 5 and includes a text box 504 in which currently constructed text is displayed and a message box in which a currently constructed message is displayed. Text box 504 is shown in FIG. 5 to include the kanji representation of “kurai” as the predicted text of text input logic 326 (FIG. 3) from the single pressing of the “2” key. Thus, it's possible that this single key represents the intended word. However, in this illustrative example, “kurai” is not the intended word.

In test step 408 (FIG. 4), text input logic 326 (FIG. 3) determines whether the user confirms that a word or phrase is complete and accurately recognized by text input logic 326. In this illustrative embodiment, a soft key is designated as a confirmation key as described more completely below. If the user has made such a confirmation, processing transfers to step 414 (FIG. 4) which is described below.

Conversely, if the user has not made such a confirmation, processing transfers through next step 418 (FIG. 4) to loop step 404 in which the next pressed key is processed according to steps 406-417. The next key pressed by the user in this illustrative example is the “5” key which represents the “n” consonant group as shown in key map 200 (FIG. 2). In step 410 (FIG. 4), text input logic 326 (FIG. 3) uses predictive database 328 to predict that the intended text is “kuni” which means “country.” In step 412 (FIG. 4), text input logic 326 (FIG. 3) determines the kanji representation of “kuni” and, in step 413 (FIG. 4), displays that representation in text box 504 as shown in FIG. 6.

The next key pressed by the user is the “1” key which represents the null consonant group. Accordingly, text input logic 326 uses predictive database 328 to predict that the intended text is “kino”—the null consonant signifying an accentuated vowel sound, namely, the long “o” —which means “yesterday” in step 410 (FIG. 4). The kanji representation for “kino” is determined in step 412 and displayed in step 413 as shown in text box 504 of FIG. 7.

The user next presses the “6” key which represents the “h” consonant group. Accordingly, the predicted text is “kino ha” which means “for yesterday” which is processed in the manner described above in steps 410-413 (FIG. 4) and is displayed in text box 504 in FIG. 8. Thus, after only four (4) key presses, text input logic 326 (FIG. 3) has correctly interpreted the intended text.

To indicate that the intended text is displayed, the user presses the confirmation key. Accordingly, processing transfers from test step 408 (FIG. 4) to step 414 in which text input logic 326 appends the text currently represented in text box 504 (FIG. 8) to a current message. The current message is initially null as shown in message box 506 (FIGS. 5-8).

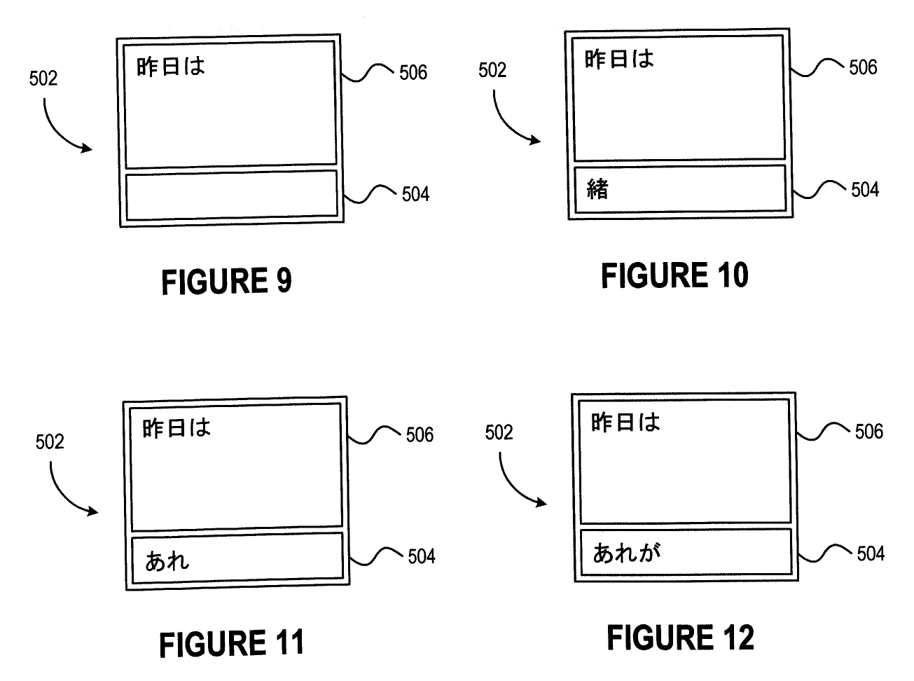

In step 416 (FIG. 4), text input logic 326 clears text box 504 and updates the message in message box 506 in step 417 as shown in FIG. 9. After step 417 (FIG. 4), processing transfers through next step 418 to loop step 404 and processing according to the loop of steps 404-418 terminates. Processing transfers to test step 420 in which text input logic 326 (FIG. 3) determines whether the user presses a confirmation key again to send the message in message box 506 (FIG. 9). If so, text input logic 326 (FIG. 3) presents the message to text communication logic 324 for sending to the intended recipient in a conventional manner in step 422 (FIG. 4). However, in this illustrative example, the message is not yet complete. Accordingly, test input logic 326 (FIG. 3) skips step 422 (FIG. 4). In either case, processing transfers through next step 424 to loop step 402 in which the next word or phrase is processed according to the loop of steps 404-418 unless the message is sent in step 422 in which case processing according to logic flow diagram 400 completes.

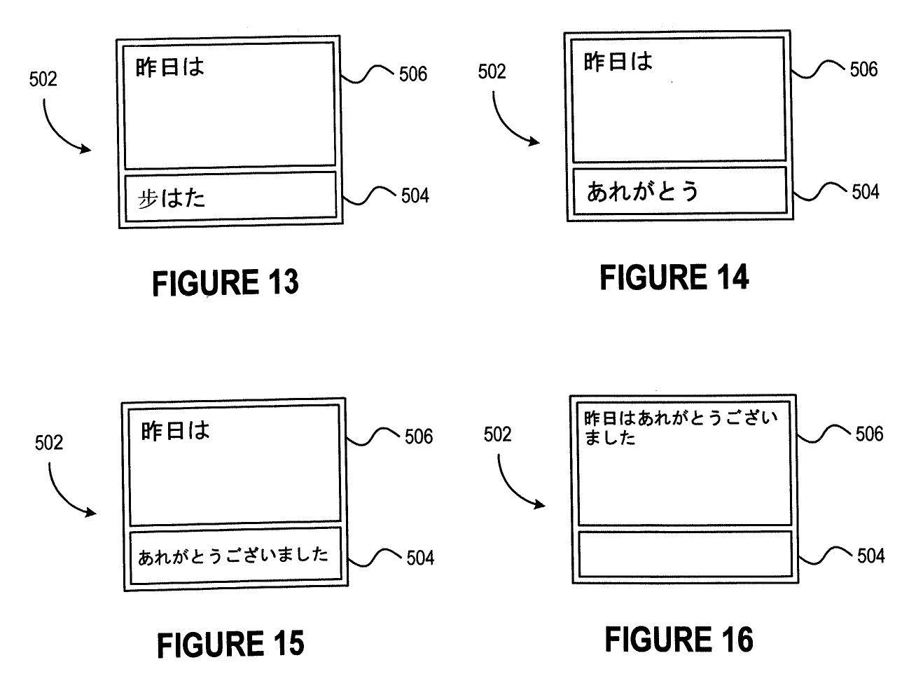

To continue in this illustrative example, the user presses the following keys in order: 1-9-2-4-1-2-<Confirm>. FIG. 10 shows the predicted word in text box 504 after pressing of the “1” key. FIG. 11 shows the predicted word in text box 504 after pressing the “9” key. FIG. 12 shows the predicted word in text box 504 after pressing the “2” key. FIG. 13 shows the predicted word in text box 504 after pressing the “4” key. FIG. 14 shows the predicted word in text box 504 after pressing the “1” key again.

FIG. 15 shows the predicted word in text box 504 after pressing the “2” key again. At this point, the user has identified a string of syllables of the following consonant groups: null, “r,” “k,” “t,” null, and “k.” Text input logic 326 predicts that the user is intending to write “arigato gozaimasu” which means “thank you very much.” It is helpful for non-Japanese speakers to understand that the Japanese “g” syllables are represented as “k” syllables with diacriticals. Thus, the correspondence between the consonant groups indicated by the illustrative key presses and the beginning syllables of “arigato gozaimasu” is apparent.

At this point, the user presses the confirmation key to indicate that the intended word or phrase is accurately represented in text box 504 (FIG. 15). In the manner described above, text input logic 326 (FIG. 3) appends the text of text box 504 to the message in message box 506 as shown in FIG. 16 and clears text box 504.

Thus, in this illustrative example, only twelve (12) key presses are required to enter the same sentence that required 40 to enter using a multi-tap system. To send the message shown in message box 506 (FIG. 16), the user presses the confirmation key. In the manner described above, the message is sent to the intended recipient.

Predictive Database 328

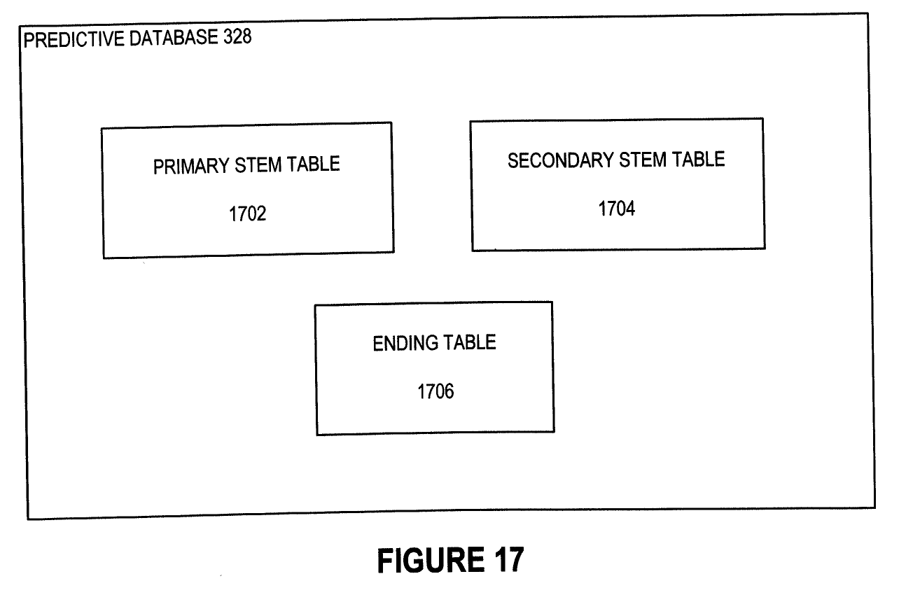

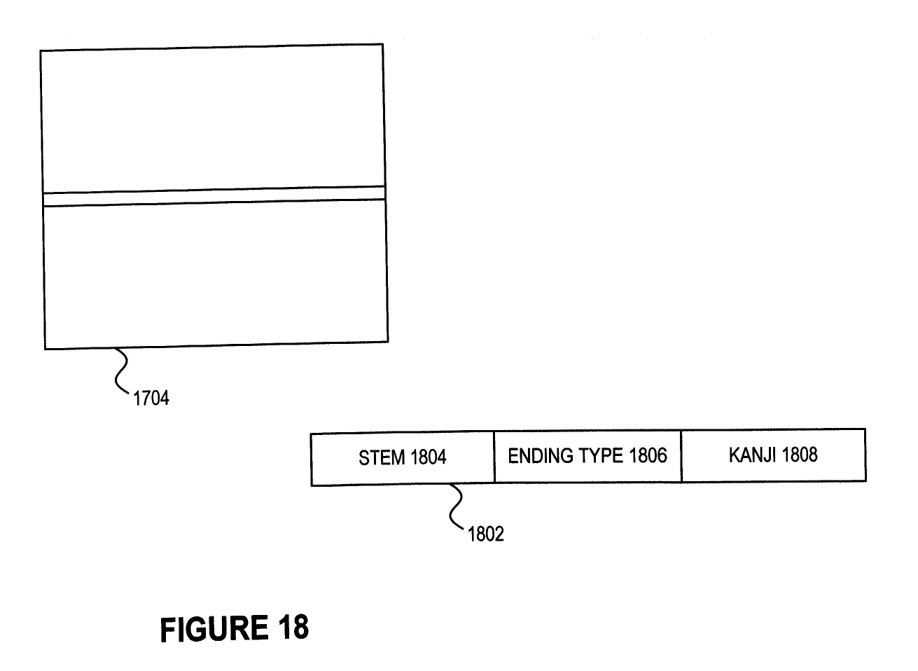

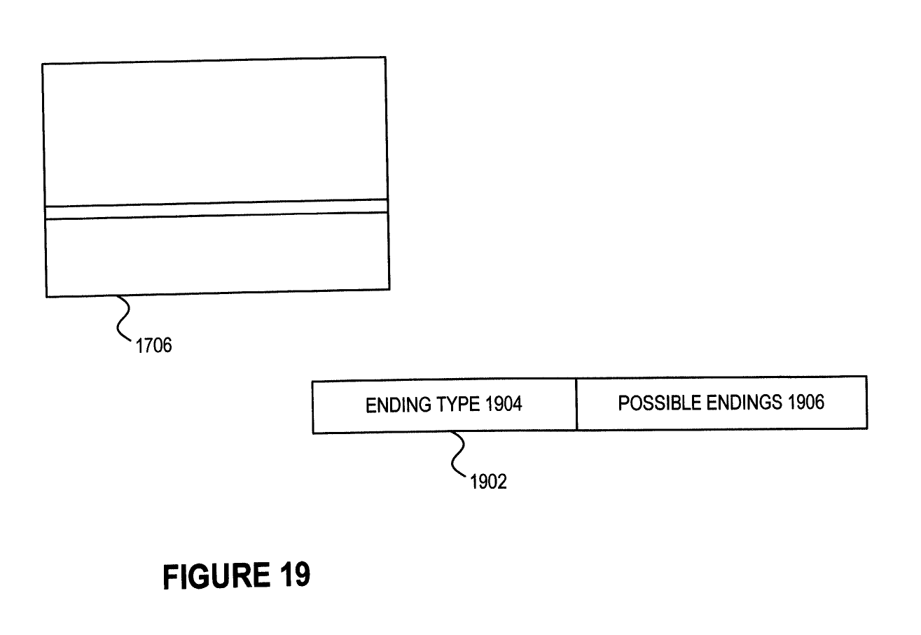

Predictive database 328 is shown in greater detail in FIG. 17 and includes a primary stem table 1702, a secondary stem table 1704, and an ending table 1706. Secondary stem table 1704 is shown in greater detail in FIG. 18. Primary stem table 1702 is analogous to secondary stem table 1704 except as otherwise noted herein. Ending table 1706 is shown in greater detail in FIG. 19.

Secondary stem table 1704 (FIG. 18) includes a number of records, e.g., record 1802, each of which includes a stem 1804, an ending type 1806, and a kanji representation 1808. Stem 1804 represents a staring portion of a word or phrase. Ending type 1806 represents a type of ending which is allowable for the word or phrase of stem 1804. Each ending type is represented in ending table 1706 (FIG. 19) which associates an ending type 1904 with possible endings 1906 in record 1902. Kanji representation 1808 specifies the proper kanji representation of the word or phrase represented by record 1802.

Primary stem table 1702 (FIG. 17) has generally the same structure as secondary stem 1704 described above. Primary stem table 1702 includes records representing the stems of the most commonly used words of the Japanese language. Secondary stem table 1704 includes records represents the stems of the remainder of the words of the Japanese language. Primary stem table 1702 is sorted such that more frequently used word stems are positioned before less frequently used word stems. Secondary stem table 1704 is sorted according numerically according to Unicode data representing each word stem.

To sort the stems represented in primary stem table 1702, the relative frequency of various words and phrases of the Japanese language is determined. Relative frequency of words and phrases of the Japanese language can be determined in various ways. The Ministry of Education, Culture, Sport, Science and Technology (MEXT) of the Government of Japan publishes relative frequencies of various characters or the Japanese language as they occur in various types of publication. MEXT publishes records of approximately ten million characters. However, the one thousand most frequently used characters represent about 90% of all characters used, and only about 2,000 characters are taught through high school in Japan. The Japanese Industrial Standard (JIS) lists approximately 7,100 characters.

Small hand-held devices such as wireless telephones have a fairly specialized purpose. Accordingly, a relatively small vocabulary—e.g., about 2,000 characters—is typically sufficient for nearly all uses on such a device. However, in this illustrative embodiment, device 300 (FIG. 3) includes the approximately 7,100 characters of the JIS. In particular, approximately 1,000 of the most frequently used word stems which account for 90% of the character usage in Japanese writing are included in primary stem table 1702 and the remaining 6,100 (approximately) least frequently used word stems are included in secondary stem table 1704. Thus, most searching is performed within primary stem table 1702 which is kept relatively small and only infrequent searching of the significantly larger secondary stem table 1704 is performed. In addition, since secondary stem table 1704 is sorted accordingly to Unicode representation of the various word stems, searching secondary stem table 1704 can be optimized. Thus, stem table searching is efficient.

The typical specialized purpose of such small hand-held devices is generally not one of the types of writings analyzed by MEXT. Accordingly, in an alternative embodiment, Internet communications is analyzed for frequency of character usage instead of, or to be combined with, frequency of usage determined by MEXT. Frequency of use in Internet communications can be analyzed by searching as much content of the World Wide Web as possible and analyzing that content. In addition, communication such as e-mail and text messages of wireless telephones can be tabulated. However, care should be taken not to retain persistent copies of messages for privacy reasons. Instead, running totals of various characters can be maintained as messages pass through on their way to intended recipients to determine relative frequencies of those characters. This latter analytical mechanism has the advantage of picking up new, technical, and slang terms that are commonly used by precisely the type of user for which the text input mechanism is intended.

As described above, keys pressed specify a string of syllables in the Japanese language. Each key represents a consonant group of syllables as shown in key map 200 (FIG. 2) and described above. Each of the hiragana characters shown in key map 200 is represented by a Unicode number. Unicode numbers are standard and are analogous to the ASCII character set by which most Western alphabets are represented in computers. In essence, a numerical value corresponds to each unique character of the hiragana syllabary. For example, the character for “ka” as shown in key map 200 has a Unicode value of 304B. All Unicode values listed herein are in hexadecimal notation. Unicode includes all syllables of key map 200, including diacritical variants and small forms. Thus, while each key represents a consonant group, each key also represents a range of Unicode values thanks to the convenient organization of Unicode. In particular, Unicode ranges for various keys are represented in the following Table.

TABLE

| Key | Unicode Range |
|---|---|
| 1 | 3041-304A, 3094 |
| 2 | 304B-3054 |
| 3 | 3055-305E |
| 4 | 305F-3069 |
| 5 | 306A-306E |
| 6 | 306F-307D |
| 7 | 307E-3082 |
| 8 | 3083-3088 |
| 9 | 3089-308D |
| 0 | 308E-3093 |

Thus, when the user has pressed the “2” key in the example above, text input logic 326 (FIG. 3) searches primary stem table 1702 (FIG. 17) for all records representing a phrase which begins with a Unicode character whose value is in the range of 304B-3054 hexadecimal and preserves the order those entries so that the entries are ordered according to relative frequency. In one embodiment of the present invention, all entries of secondary stem table 1704 are appended to the list as least frequently used entries. In an alternative embodiment, secondary stem table 1704 is only searched if fewer than a predetermined number of, e.g., three (3), word stems of primary stem table 1702 are matched by the keys pressed by the user.

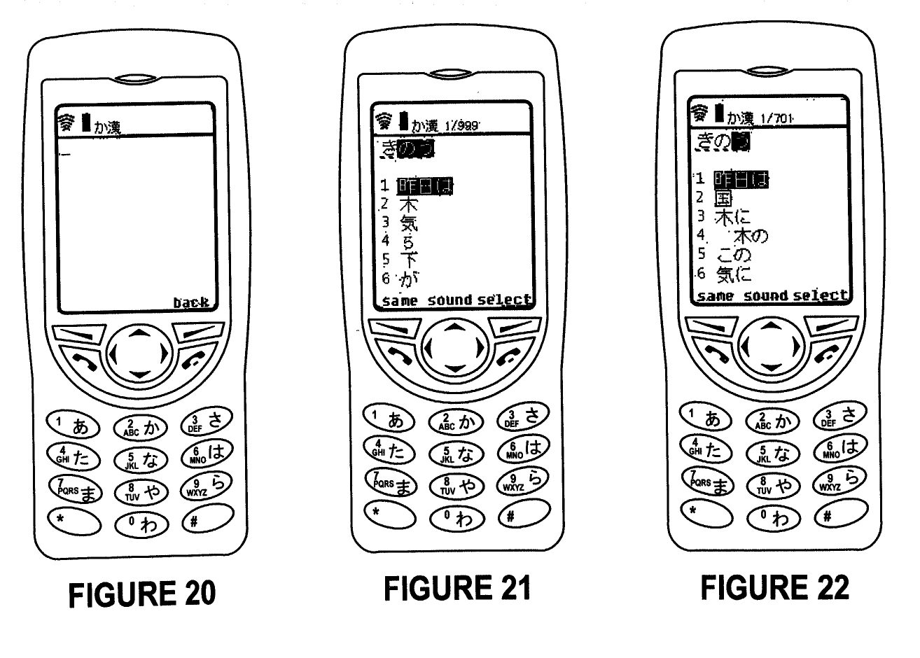

Of course, this list would be very large. FIG. 20 shows a wireless telephone capable of text messaging as an illustrative embodiment of the present invention. FIG. 21 shows the same wireless telephone in which the “2” key has been pressed to begin entry of a text message. At the top of the display portion of the wireless telephone, the text “1/999” indicates that 999 or more candidate words and phrases are listed. Accordingly, the user would likely press another key to specify a second syllable, e.g., by pressing the “5” key in the above example. In response, text input logic 326 searches primary stem table 1702 (and perhaps secondary stem table 1704) for all phrases whose first Unicode character has a value in the range of 304B-3054 and whose second Unicode character has a value in the range of 306A-306E. This list will be considerably shorter than the first list, and the odds that the intended word or phrase is near the top of the list is dramatically improved since the list is sorted by relative frequency score.

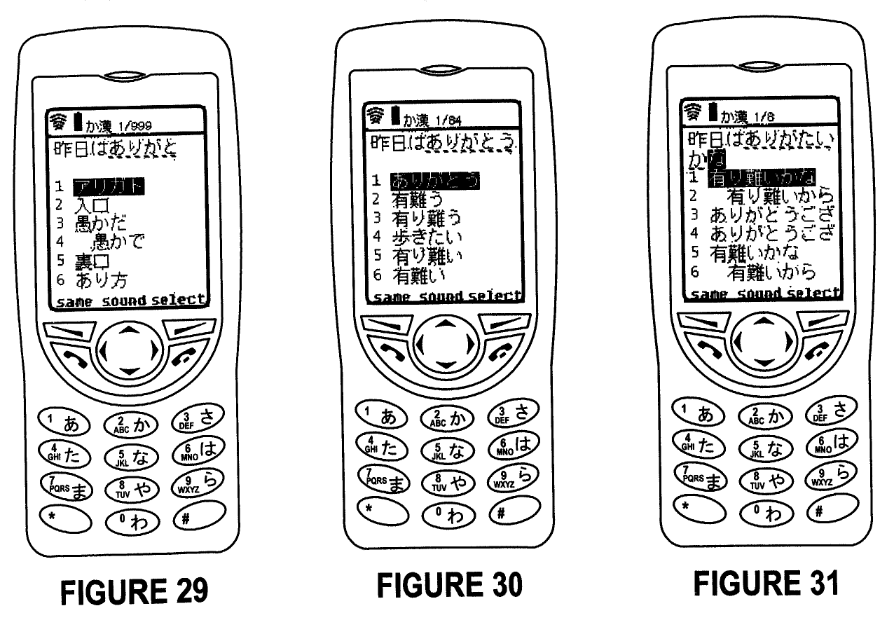

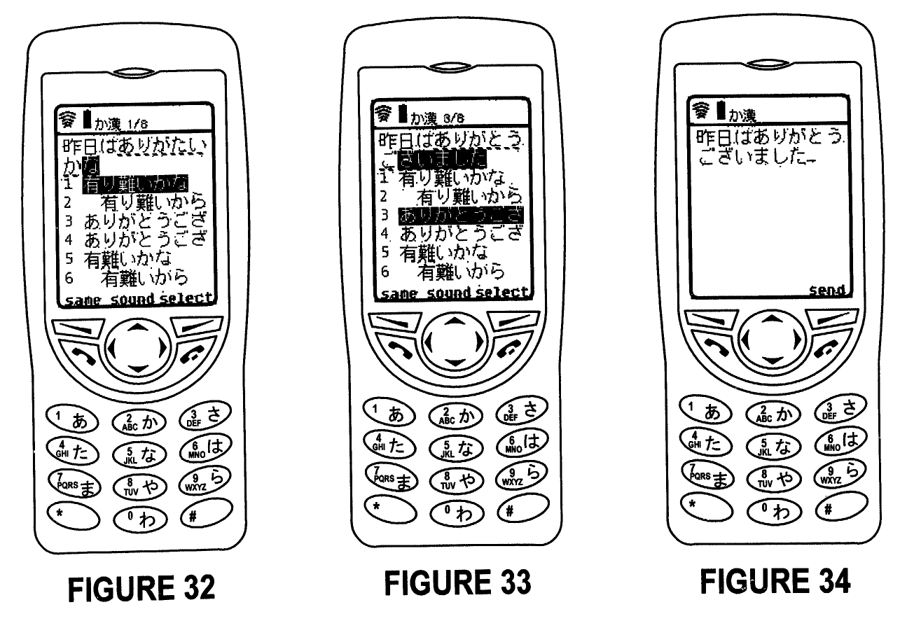

At this point, it is useful to note a feature of the wireless telephone of FIGS. 20-34. The predicted text of text box 504 of FIG. 5 is listed as the second most likely textual candidate and the precise phrase “for yesterday” is listed as the most likely candidate. Text input logic 326 (FIG. 3) stores previously entered phrases of device 300 in a separate table which is given higher priority than stems of primary stem table 1702. Accordingly, previously entered phrases are given the highest ranking during subsequent text entry sessions. Accordingly, the behavior of text input logic 326 (FIG. 3) adapts to the particular user's writing style. Thus, the user can immediately select the phrase “for yesterday” after pressing a single key. However, for illustration purposes, the entire above example of FIGS. 5-16 is shown in FIGS. 20-34.

And, as described above, the candidates presented to the user ranked by predictive logic in the manner described above, are presented as kanji or kanji combined properly with kana. However, the user enters the text in the manner described above by specifying groups of kana characters only. To accomplish the kanji-kana representation, text input logic 326 uses stem tables 1702-1704 and ending table 1706.

A kanji-kana representation for a kana word or phrase is determined by finding—within either of stem tables 1702-1704—a record such as record 1802 (FIG. 18) with stem 1804 which matches the kana word or phrase and allows the ending as represented by ending type 1806 in conjunction with ending table 1706. When a match is found, the kana word or phrase is represented by kanji 1808. Thus, the predicted text items of FIG. 21 which are listed as items 1, 2, 3, 4, 5, and 6 are in proper kanji-kana form.

In an alternative embodiment, the kana form of the text entered by the user is preserved and the list of predicted words and phrases is represented using only kana, e.g., hiragana. The user can convert any accepted kana text to kanji-kana. Such conversion can be performed in the manner described above or using any conventional kana-kanji conversion.

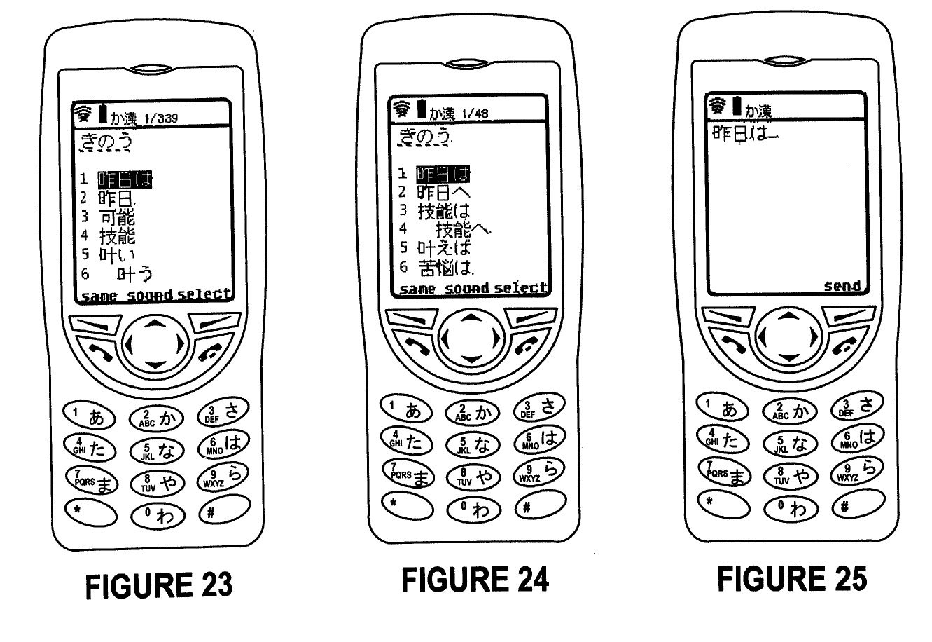

To continue entry of text, the user continues to press keys of the numeric keypad in the illustrative example of FIGS. 20-34. The list shortens with each press of a key. In FIG. 22, after the user has pressed “25,” the list of candidate phrases is 701 phrases long. In FIG. 23, after the user has pressed “251,” the list of candidate phrases is 339 phrases long. In FIG. 24, after the user has pressed “2516,” the list of candidate phrases is 48 phrases long. FIG. 25 shows that the user has selected the phrase “for yesterday” by pressing the soft key labeled “select” and the phrase is displayed as the current message.

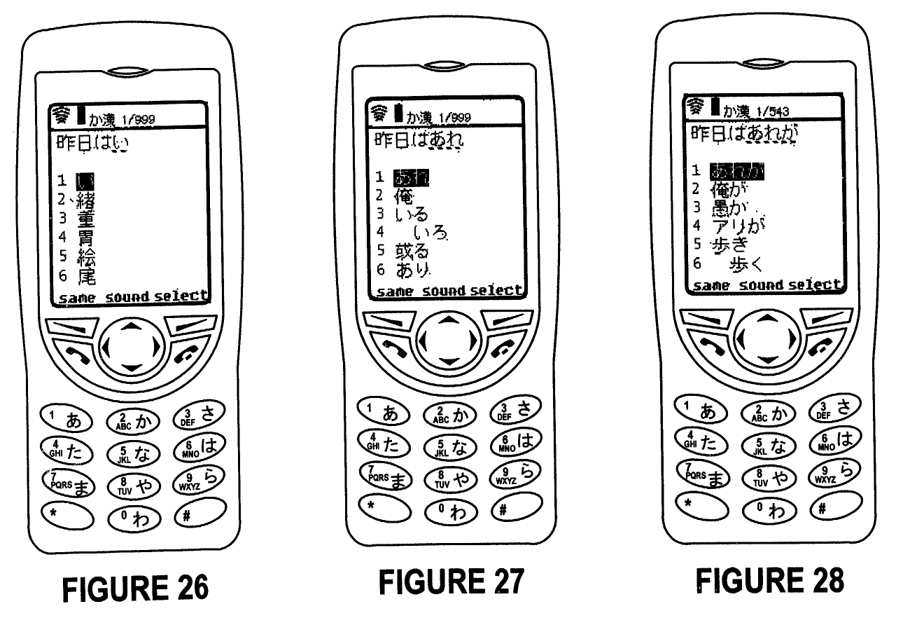

To complete the message, the remainder of the syllables are specified, with one key press for each syllable, in the manner described above to enter “thank you very much” in FIGS. 26-33 and the phrase is appended to the message as described above and as shown in FIG. 34. The message is now entered and ready to be processed, e.g., by sending the text to another user.

Another feature alluded to in the illustrative embodiment shown in FIGS. 20-34. A soft key is labeled “same sound.” The Japanese language has numerous homonyms. Accordingly, a complete spelling out of a word using the phonetic syllables of the fifty sound table can have multiple interpretations. Only the proper kanji representation of the word can be unambiguously interpreted. The user can focus in on the intended text unambiguously by highlighting the word from the list of predicted words and phrases and pressing the “same sound” soft key.

In response, text input logic 326 (FIG. 3) removes all non-homonyms of the selected word or phrase from the list of predicted words and phrases. Accordingly, the list of predicted words and phrases becomes quite short and the intended phrase can be readily selected by the user.

The above description is illustrative only and is not limiting. For example, while text messaging using a wireless telephone is described as an illustrative embodiment, it is appreciated that text entry in the manner described above is equally applicable to many other types of text entry. Wireless telephones use text entry for purposes other than messaging such as storing a name of the wireless telephone's owner and associating textual names or descriptions with stored telephone numbers. In addition, devices other than wireless telephones can be used for text messaging, such as two-way pagers and personal wireless e-mail devices. Personal Digital Assistants (PDAs) and compact personal information managers (PIMs) can utilize text entry in the manner described here to enter contact information and generally any type of data. Entertainment equipment such as DVD players, VCRs, etc. can use text entry in the manner described above for on-screen programming or in video games to enter names of high scoring players. Video cameras with little more than a remote control with a numeric keypad can be used to enter text for textual overlays over recorded video. Japanese text entry in the manner described above can even be used for word processing or any data entry in a full-sized, fully-functional computer system.

Therefore, this description is merely illustrative, and the present invention is defined solely by the claims which follow and their full range of equivalents.

what is claimed is:

1. A method for generating Japanese text in response to signals generated by a user, the method comprising:
receiving signals generated by the user which specify one or more collections each of which includes one or more syllables;
determining that one or more predicted words include any syllable of each of the one or more collections;
presenting the one or more predicted words to the user for selection.

2. The method of claim 1 wherein the one or more collections are each associated with a respective consonant.

3. The method of claim 2 wherein a vowel one of the one or more collections is associated with a null consonant.

4. The method of claim 2 wherein each of the one or more collections corresponds to a row of a fifty sounds table.

5. The method of claim 1 wherein the signals generated by the user specify each of the one or more collections in response to a corresponding individual action taken by the user.

6. The method of claim 5 wherein each individual action taken by the user is a single key press.

7. The method of claim 1 further comprising:
determining a kanji representation of each of the one or more predicted words; and
wherein presenting the one or more predicted words comprises presenting the kanji representation of each of the one or more predicted words.

8. The method of claim 1 wherein presenting the one or more predicted words comprises:
presenting the one or more predicted words in order of relative frequency of use.

9. A computer readable medium useful in association with a computer which includes a processor and a memory, the computer readable medium including computer instructions which are configured to cause the computer to generate Japanese text in response to signals generated by a user by:
receiving signals generated by the user which specify one or more collections each of which includes one or more syllables;
determining that one or more predicted words include any syllable of each of the one or more collections;
presenting the one or more predicted words to the user for selection.

10. The computer readable medium of claim 9 wherein the one or more collections are each associated with a respective consonant.

11. The computer readable medium of claim 10 wherein a vowel one of the one or more collections is associated with a null consonant.

12. The computer readable medium of claim 10 wherein each of the one or more collections corresponds to a row of a fifty sounds table.

13. The computer readable medium of claim 9 wherein the signals generated by the user specify each of the one or more collections in response to a corresponding individual action taken by the user.

14. The computer readable medium of claim 13 wherein each individual action taken by the user is a single key press.

15. The computer readable medium of claim 9 wherein the computer instructions are configured to cause the computer to generate Japanese text in response to signals generated by a user by also:
determining a kanji representation of each of the one or more predicted words; and
wherein presenting the one or more predicted words comprises presenting the kanji representation of each of the one or more predicted words.

16. The computer readable medium of claim 9 wherein presenting the one or more predicted words comprises:
presenting the one or more predicted words in order of relative frequency of use.

17. A device comprising:
at least one input module for enabling a user to generate input signals;
at least one display module; and
user input logic (i) which is operatively coupled between the input device and the display device and (ii) which generates Japanese text in response to the input signals generated by the user by:
receiving the input signals generated by the user through the input module wherein the input signals specify one or more collections, each of which includes one or more syllables;
determining that one or more predicted words include any syllable of each of the one or more collections;
presenting the one or more predicted words to the user for selection in the display module.

18. The device of claim 17 wherein the one or more collections are each associated with a respective consonant.

19. The device of claim 18 wherein a vowel one of the one or more collections is associated with a null consonant.

20. The device of claim 18 wherein each of the one or more collections corresponds to a row of a fifty sounds table.

21. The device of claim 17 wherein the input signals generated by the user specify each of the one or more collections in response to a corresponding individual action taken by the user.

22. The device of claim 21 wherein each individual action taken by the user is a single key press of the input module.

23. The device of claim 17 wherein the text input logic generates Japanese text in response to the input signals generated by the user by also:
determining a kanji representation of each of the one or more predicted words; and
wherein presenting the one or more predicted words comprises presenting the kanji representation of each of the one or more predicted words in the display module.

24. The device of claim 17 wherein presenting the one or more predicted words comprises:
presenting the one or more predicted words in order of relative frequency of use.

25. The device of claim 17 wherein the device is a wireless telephone.

26. The device of claim 17 wherein the device is a text messaging device.

27. The device of claim 17 wherein the device is a computer.

28. The device of claim 17 wherein the input module comprises a numerical keypad.
